(19) United States
(12) Patent Application Publication
(10) Pub. No.: US 2008/0072694 A1
(43) Pub. Date: Mar. 27, 2008

(54) OSCILLATING VANE MACHINE WITH IMPROVED VANE AND VALVE ACTUATION

(76) Inventor: STEPHEN M. CHOMYSZAK, ATTLEBORO, MA (US)

Correspondence Address: ELMORE PATENT LAW GROUP, PC, 209 MAIN STREET, N. CHELMSFORD, MA, 01863, US

(21) Appl. No.: 11/858,951

(22) Filed: Sep. 21, 2007

Related U.S. Application Data
(60) Provisional application No. 60/846,543, filed on Sep. 22, 2006.
(60) Provisional application No. 60/889,315, filed on Feb. 12, 2007.
(60) Provisional application No. 60/910,040, filed on Apr. 4, 2007.

(51) Int. Cl. F04D 29/20; F16H 29/02

(52) U.S. Cl. 74/89; 415/163

(57) ABSTRACT

The present invention is directed to an oscillating vane machine where the vanes can be operated at high speed with a minimum of vibration and with minimum mechanical loads accomplished with sinusoidal motion of the vanes utilizing an improved continuously rotating input/output which is naturally balanced.

### RELATED APPLICATIONS

This application claims priority to U.S. Provisional Application No. 60/910,040 filed on Apr. 4, 2007, U.S. Provisional Application No. 60/889,315 filed on Feb. 12, 2007 and U.S. Provisional Application No. 60/846,543 filed on Sep. 22, 2006. The entire teachings of the above application(s) are incorporated herein by reference.

### BACKGROUND OF THE INVENTION

This invention generally pertains to oscillating vane machines, which have the potential to produce high flow and high pressures from small and inexpensive packages if the oscillating vanes can be operated at sufficient speeds with a minimum of vibration and if the fluid flow of the machine can be arranged to support such high flow rates. More specifically, the present invention relates to a machine which can be adapted for use either as a compressor or as an expander comprising improvements in the methods of vane and valve actuation which allow oscillating vane machines to operate at higher speeds with reduced vibration and provide significant increases in flow rate.

Oscillating vane machines have been described in the art. U.S. Pat. No. 2,257,884, issued Oct. 7, 1941 to Mize, U.S. Pat. No. 2,393,204, issued Jan. 15, 1946 to Taylor, U.S. Pat. No. 4,099,448, issued Jul. 11, 1978 to Young, U.S. Pat. No. 4,823,743, issued Apr. 25, 1989 to Ansdale, U.S. Pat. No. 5,228,414, issued Jul. 20, 1993 to Crawford and U.S. Pat. No. 4,080,114, issued Mar. 21, 1978 to Moriarty, the contents of which are incorporated herein by reference in their entirety.

Oscillating vane machines have the potential to provide extremely high flow rates and pressures, but in order to do so, they require vane actuation and valving suitable for high speed operation. The prior art teaches against these requirements by disclosing methods which limit the machine's potential due to vibration resulting from poor vane actuation and/or fluid starvation due to insufficient port area and valve control.

The machine of Mize places a plurality of oscillating vanes in a common main chamber and relies on the ability of the vanes to seal against each other at their pivots to prevent high pressure fluid from leaking to low pressure areas. This type of seal is, at best, a line contact and is insufficient for high pressures. In Mize, the oscillating vanes are actuated via a continuously rotating crankshaft like, as known to those skilled in the art, those used in reciprocating piston machines. The fluid enters and exits the chambers through fixed, radially positioned ports which are covered and uncovered by the distal ends of the vanes as they oscillate. The fluid path of this machine is very much like that of two-stroke reciprocating piston engines where an incoming charge of fresh air is used to expel a previously combusted charge of exhaust gas. As such, the porting arrangement of Mize does not allow the oscillating vanes to provide an efficient inlet process by themselves; therefore, Mize utilizes an integrated centrifugal blower to charge the chambers with fresh air. Mize's preferred embodiment utilizes 4 oscillating vanes driven via a crankshaft with an individual crank throw for each of the 4 vanes.

Taylor discloses an oscillating vane machine used as a hydraulic motor whereby a single vane is contained within a single main chamber thereby making it more practical to seal the vane and its pivot. This type of arrangement is better suited for higher pressures; however, the actuation of a single oscillating vane at high speed will produce excessive vibration unless a counterbalance is used.

Young discloses a two-vane machine driven via a gear set and over-running clutches on the shaft of each vane. Over-running clutches do not provide reliable synchronized motion as is required by oscillating vane machines at high speed. In one embodiment a pair of rotary valves is disclosed to control the flow of fluid into and out of the machine. In yet another embodiment, Young utilizes a complicated series of rotary valves in conjunction with poppet valves. Every time a fluid passes through a valve, it loses energy and represents a source of inefficiency. In this embodiment, the fluid must pass through no less than five valves per circuit representing a highly inefficient fluid path. Poppet valves, however, have the advantage of being able to seal by pressure loading without generating friction.

Ansdale discloses a single vane machine whereby the vane is driven via a crankshaft with a separate counterbalance to reduce vibration. In one embodiment, Ansdale uses pressure activated reed valves. In another embodiment is disclosed cam and spring actuated poppet valves with timed opening and closing, and in a third embodiment, rotary valves are used with timed opening and closing. Ansdale begins to address the balance issues but the machine will have difficulties achieving high flow rates due to the very limited passage sizes allowed for fluid flow.

Moriarty discloses a machine whereby two diametrically opposed vanes are attached to a single pivot. He calls this assembly a piston assembly and shows one embodiment, which utilizes one piston assembly, and another embodiment which utilizes two piston assemblies. He also discloses improvements on a nutating drive mechanism with a continuously rotating input/output shaft, used to actuate the oscillating piston assemblies. Moriarty also discloses a novel flow path for the fluid entering the piston chambers through the vane pivots and then through the vanes themselves with the opening and closing of the ports in the vanes being controlled with a flapper valve activated by inertia and pressure differences. He also uses various reed valves in additional embodiments for fluid inlet and discharge. As with all of the previous machines, Moriarty does not provide a fluid path which will support high flow rates while keeping the machine small.

An oscillating vane machine designed to maximize its potential will preferably utilize pairs of counter-rotating vanes which will self balance the oscillating vane masses in conjunction with a drive arrangement which is compact, self-balanced, and suitable for high speed operation. In addition, the machine must have an efficient fluid path with valves and ports that provide adequate areas to promote high flow rates which can be reliably operated at high speeds with a minimum of friction while containing high pressures.

It is known that optimization of ‘unloading’ and ‘capacity control’ can save improve flexibility of a compressor during operation in relation to energy savings. However, in the case where oscillating vane machines can be used as compressors, these features have been altogether ignored by the prior art.

An unloader is a device which prevents the compressor from generating pressure until it has reached operating speed. A compressor is typically ‘unloaded’ during start up in order to limit the amount of current draw from the motor. This allows the use of low cost motors with limited current capabilities. Once the compressor is up to operating speed, the unloader is deactivated and the compressor becomes ‘loaded’ and then begins to generate pressure.

Capacity control is utilized to vary the flow rate of a compressor while the compressor runs at a continuous speed. In cases where a compressor is used in applications with variable flow requirements, capacity control helps to reduce the power consumption of the compressor during low flow situations but allows the compressor to deliver enough fluid during high flow situations. Although capacity control can be accomplished using a variable speed motor, the variable speed drives necessary to control the motor are currently very expensive and therefore a less expensive mechanical form of capacity control is desirable.

### SUMMARY OF THE INVENTION

Accordingly, it is an object of this invention to provide a new and improved oscillating vane machine which can be used as a compressor or expander.

Specifically, it is an object of the present invention to provide an oscillating vane machine where the vanes can be operated at high speed with a minimum of vibration and with minimum mechanical loads accomplished with sinusoidal motion of the vanes utilizing an improved continuously rotating cam mechanism which is naturally balanced.

Another object of the invention is to provide an oscillating vane machine with improved port area and valve actuation and control.

Another object of the invention is to provide a fluid path into and out of the machine that is easily scalable and provides sufficient flow areas in order to reduce pumping losses.

Another object of the invention is to provide a compressor with load/unload features.

Another object of the invention is to provide a compressor with capacity control features.

Another object of the invention is to provide a multi-staged compressor or expander.

In accordance with the present invention is provided an oscillating vane machine comprising: (a) a plurality of pivoted vanes each comprising (i) a vane, said vane being defined by a first side vane surface, a second side vane surface, a distal vane surface, a first lateral vane surface and a second lateral vane surface, wherein said distal vane surface defines a distal vane surface path and said first and second lateral vane surfaces define first and second lateral vane surface paths when the vane is rotated about a pivot axis, and (ii) a pivot comprising said pivot axis, (b) a plurality of individual main chambers each defined by (i) a distal chamber surface which is defined by said distal vane surface path, (ii) a first end wall chamber surface, (iii) a second end wall chamber surface, (iv) a first lateral chamber surface defined by said first lateral vane surface path and extending from the radius of the vane pivot to the distal chamber surface, and (v) a second lateral chamber surface defined by said second lateral vane surface path and extending from the radius of the vane pivot to the distal chamber surface, (c) a driver which drives all pivoted vanes in a balanced and oscillating motion; (d) at least one inlet port in fluid communication with each individual main chamber; and (e) at least one discharge port in fluid communication with each individual main chamber.

The oscillating vane machine may further comprise a housing or stator. In one embodiment, the pivots of the pivoted vanes form a conformal seal with the housing or stator. The art of sealing parts such as those of the present invention is known to those skilled in the art.

Further, the housing or stator may be coincident with one or more surfaces of said plurality of individual main chambers.

In one embodiment, the distal vane surface of each pivoted vane forms a seal with the distal chamber surface of each individual main chamber in which it is located. The surfaces forming the plurality of individual main chambers may have a coefficient of friction less than 0.5.

In a preferred embodiment, the oscillating vane machine of the invention has four individual main chambers and has one pivoted vane disposed in each chamber. The pivoted vanes may be fixed equidistant from one another.

In one embodiment, the pivoted vanes are rotated about their pivots at a 45, 60 or 90 degree angle. Furthermore, the pivoted vanes may also be double-acting.

In one embodiment, the first and second lateral chamber surfaces are fixed.

In one embodiment, the inlet and discharge ports may be located in the lateral chamber surfaces, the end wall surfaces, or the distal surface of the individual main chambers.

In one embodiment the driver of the oscillating vane machine of the invention is selected from the group consisting of a rack and pinion system, a cam and camshaft, a rod and crankshaft, a desmodromic drive system, a cam with one or more springs, a cam and rod, reciprocating gears attached to the pivots, a dual cam with pins, a dual cam with gears, a tangential torquing device, and any combination thereof. The driving mechanisms may also be balanced using a counterbalance. The inlet and discharge ports of the invention may be valves and in certain embodiments these valves are in fluid communication with one or more suction volumes. When operating in an open loop a first stage suction volume may be represented by the atmosphere while a second stage said suction volume is the discharge of the first stage. In a closed loop, the suction volume of the inlet valve may communicate with the loop itself or a low pressure section of the loop while the discharge valves may communicate with one of a high press section of said closed loop, a discharge tank or inlet of a downstream stage.

The valves may also be extensible with the oscillating vane machine.

In one embodiment, the valves may be any of stationary, rotary, hinged, poppet or an array of poppet either linear or otherwise, reed (or high frequency valve), flapper and any combination thereof.

In one embodiment, the valves are actuated mechanically. In another embodiment actuation to open the valves is achieved as a result of differential pressure across the valves and actuation to close the valves is achieved mechanically.

In one embodiment the oscillating vane machine may further comprise one or more unloaders, capacity control devices, or intercoolers. The capacity control device may be selected from the group consisting of a valve, a bypass circuit, a throttle plate and any combination thereof. The cooling systems may use water as a coolant.

In one embodiment the oscillating vane machine of the invention acts as a compressor.

In one embodiment, the inlet of fluid into the inlet port is timed such that the machine operates as an expander.

The main chambers of the oscillating vane machine of the invention may be multi-staged and multi-staging may occur in 2 or more stages. Further, multiple machines may also act in concert to effect multistage compression or expansion.

### BRIEF DESCRIPTION OF THE DRAWINGS

The foregoing and other objects, features and advantages of the invention will be apparent from the following more particular description of the embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a view of a pivoted vane—PRIOR ART.

FIG. 2 is a view of a chamber in which a pivoted vane oscillates.—PRIOR ART.

FIG. 3A is a view of a machine with a single pivoted vane.—PRIOR ART.

FIG. 3B is a view of a machine with two dual-vaned pivots—PRIOR ART.

FIG. 3C is a view of the oscillating vane machine of the present invention with four main chambers each comprising one pivoted vane.

FIG. 4A is a graph of the preferred sinusoidal acceleration and deceleration profiles of an oscillating pivoted vane.

FIG. 4B is a graph of the sinusoidal acceleration and deceleration profiles of an oscillating pivoted vane when driven via a crankshaft.

FIG. 5A is a view of another embodiment of the oscillating vane machine of the present invention illustrating the actuation face of a machine with four main chambers each comprising a pivoted vane with each of the four pivoted vanes being driven via a reciprocating rack and pinion in which the racks are actuated via a symmetrical cam where one revolution of the cam produces two complete sinusoidal oscillations of each of the four pivoted vanes. The cam is labeled with a reference mark to illustrate the concerted movement of and within the machine.

FIG. 5B is a view of the embodiment of FIG. 5A having the cam removed for visual clarity.

FIG. 5C is a sequence of views of the embodiment of FIG. 5A illustrating the concerted movement of and within the machine upon rotation of the cam. The cam is labeled with a reference mark 49 to illustrate the concerted movement of and within the machine.

FIG. 6A is a view of another embodiment of the oscillating vane machine of the present invention showing the actuation face of the machine where a reciprocating structure with two geared racks is driven via a conventional crankshaft and connecting rod. Each of the two racks is geared to an extended pinion gear whereby each extended pinion is directly connected to a vane pivot and where each extended pinion provides rotary input to a respective shorter pinion so that each revolution of the crankshaft produces one complete rotary oscillation of each of the four vanes via the reciprocating motion of the rack structure.

FIG. 6B is and elevation view of the machine of FIG. 6A.

FIG. 7A is a view of another embodiment of the oscillating vane machine of the present invention showing the actuation face of the machine with four pivoted vanes with each of the four pivots being driven via a synchronous belt and pulley in which the belts are actuated via four reciprocating drive members which in turn are actuated via a symmetrical cam where one revolution of the cam produces two complete sinusoidal oscillations of each of the four vanes. The cam is not shown but is identical to the cam used in FIG. 5A.

FIG. 7B is an end view of the machine of FIG. 7A.

FIG. 8 is a view of another embodiment of the oscillating vane machine of the present invention showing the actuation face of the machine. This embodiment shows a single-acting actuated oscillating vane machine of the present invention having four pivoted vanes with a grooved cam which actuates a pin connected to a pinion whereby one revolution of the cam produces one complete sinusoidal oscillation of each of the four pivoted vanes.

FIG. 9 is a view of another embodiment of the oscillating vane machine of the present invention showing the actuation face of the machine. This embodiment shows a double-acting actuated oscillating vane machine of the present invention having four pivoted vanes with a cam which actuates four pins each connected to a pinion whereby one revolution of the cam produces two complete sinusoindal oscillations of each of the four vanes.

FIG. 10 is a view of another embodiment of the oscillating vane machine of the present invention showing the actuation face of the machine. This embodiment shows a triple-acting actuated oscillating vane machine of the present invention having four pivoted vanes with a grooved cam which actuates a pin connected to a pinion whereby one revolution of the cam produces three complete sinusoidal oscillations of each of the four pivoted vanes.

FIG. 11 is a view of another embodiment of the oscillating vane machine of the present invention showing the actuation face of the machine. This embodiment shows a quadruple-acting actuated oscillating vane machine of the present invention having four pivoted vanes with a dual cam which actuates four pins connected in pairs to each of two pinions whereby one revolution of the cam produces four complete sinusoindal oscillations of each of the four vanes. The dual cam is shown as being transparent.

FIG. 12 is a view of a dual cam useful as a driver of the oscillating vane machine of FIG. 11.

FIG. 13 is a view of the oscillating vane machine showing the actuation face of the machine of FIG. 11, with the dual cam removed to illustrate the location of the two pairs of pins whereby each pair consists of a short and long pin.

FIG. 14A is a view of another embodiment of the oscillating vane of the present invention showing the actuation face of the machine. This embodiment shows a single-acting machine with reciprocating plate as an actuation mechanism.

FIG. 14B is a view of the embodiment of FIG. 14A having the reciprocating plate removed for visual clarity.

FIG. 15A is a view of an axial face (here a porting face) of the oscillating vane machine of the present invention illustrating the inlet ports and valves.

FIG. 15B illustrates the beginning of a cycle of fluid flow into the machine and the actuation of the valves.

FIG. 16 is a view of one unit of an inlet valve assembly.

FIG. 17 is a view of multiple inlet valve and discharge valve assemblies of an oscillating vane machine of the present invention.

FIG. 18A is a view of an axial face (here a porting face) of the oscillating vane machine of the present invention illustrating the discharge ports and valves.

FIG. 18B is an end view of FIG. 18A showing the arrangement of the discharge valves.

FIG. 19 is a view of one unit of a discharge valve assembly of the present invention.

FIG. 20A is a view of an embodiment of the machine showing the inlet face of the machine and the radially oriented inlet ports arranged around the outer periphery of the machine.

FIG. 20B is a view of an embodiment of an extended machine showing the inlet face of the machine and the extended radially oriented inlet ports arranged around the outer periphery of the machine.

FIG. 20C is a view of the machine in FIG. 20A showing the discharge face of the machine and the radially oriented discharge ports arranged around the outer periphery of the machine.

FIG. 20D is a view of the extended machine of FIG. 20C showing the discharge face of the machine and the extended radially oriented discharge ports arranged around the outer periphery of the machine.

FIG. 21A is a view of an embodiment of the machine showing the inlet face of the machine and the axially oriented inlet ports arranged on the inlet face of the machine.

FIG. 21B is a view of the machine of FIG. 21A showing the discharge face of the machine and the axially oriented discharge ports arranged on the discharge face of the machine.

FIG. 22 is a view of one embodiment of the oscillating vane machine of the present invention illustrating a dwell-containing cam.

FIG. 23 is a graph of the preferred sinusoidal acceleration and deceleration profiles of an oscillating pivoted vane configured in the oscillating vane machine of the present invention having a dwell-containing cam.

### DETAILED DESCRIPTION OF THE INVENTION

A description of the preferred embodiments of the invention follows. Referring now to the drawings wherein the views are for purposes of illustrating preferred and alternate embodiments of the invention only and not for purposes of limiting same. While the oscillating vane machine is designed for and will hereinafter be described as either a compressor or an expander, it will be appreciated that the overall inventive concept involved could be adapted for use in many other machine environments as well, such as engines and pumps.

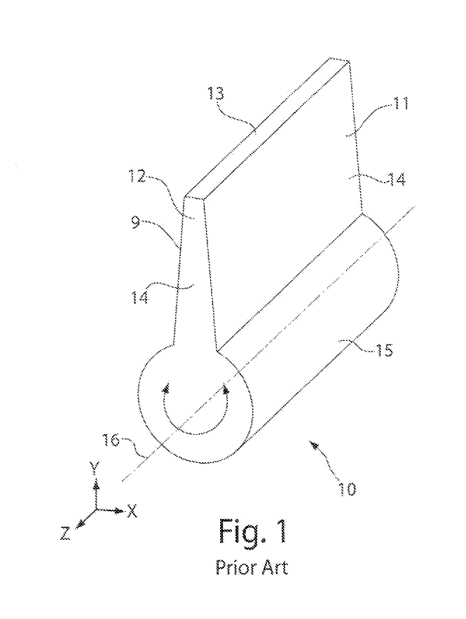

Reference is now made to the figures. FIG. 1 shows an embodiment in the prior art of a single pivoted vane 10 which is comprised of a vane 9 and a vane pivot 15. The vane further comprises a first side vane surface 11, a second side vane surface 12, a distal vane surface 13 and a pair of (a first and a second) lateral vane surfaces 14. The pivoted vane rotates or oscillates about a pivot axis 16. It is understood that because the vane oscillates or pivots within the chamber that the first and second side vane surfaces may be referred to “leading” and “trailing” surfaces. These terms are relative to the direction the pivoted vane is moving and therefore the naming of side vane surfaces 11 and 12 are interchangeable when discussing the direction the pivoted vane is moving.

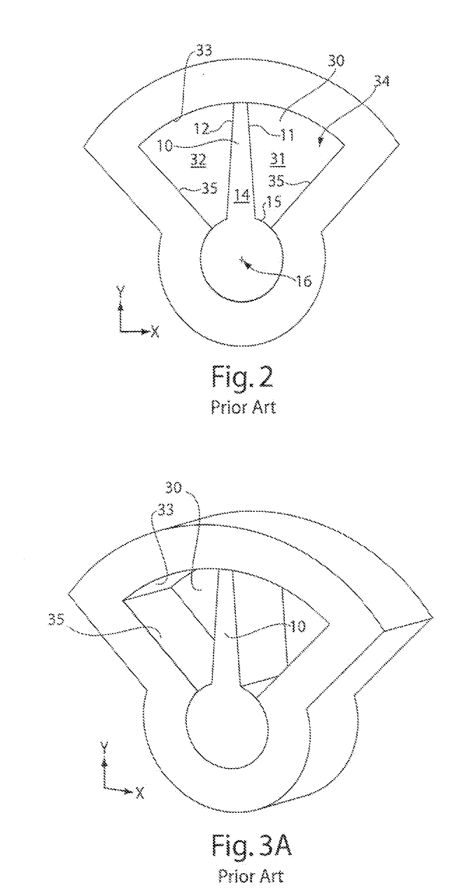

FIG. 2 shows a pivoted vane 10 within a single main chamber 30. The open space of the main chamber when occupied by a pivoted vane is defined by a leading chamber 31, a trailing chamber 32. It is understood that because the vane oscillates or pivots within the chamber that “leading” and “trailing” are relative to the direction the pivoted vane is moving and therefore the labeling of chambers 31 and 32 are interchangeable depending on the direction of the pivoted vane. The chamber is further defined by a distal chamber surface 33 defined by said distal vane surface 13 path, two (a first and a second) end wall chamber surfaces 35 and two (a first and a second) lateral chamber surfaces 34 defined by said lateral vane surface 14 paths extending from the radius of the vane pivot 15 to the distal chamber surface 33. In the figure view, the plane of the drawing defines one of the lateral chamber surfaces 34. The distal vane surface 13 defines a distal vane surface path and the pair of lateral vane surfaces 14 define a pair of lateral vane surface paths when each vane is rotationally oscillated about its axis of rotation 16.

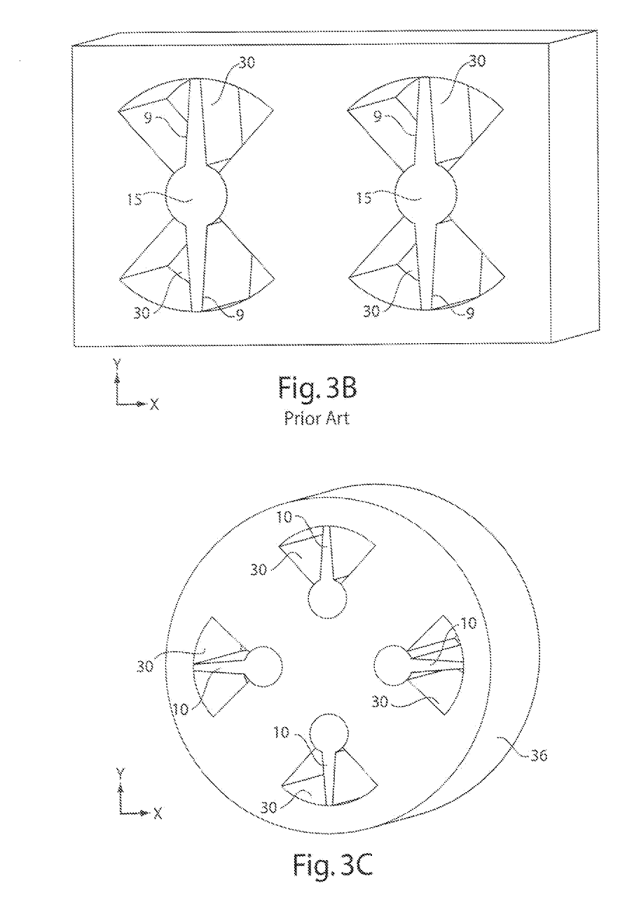

FIG. 3A shows a single pivoted vane 10 operating in a single main chamber 30.

FIG. 3B shows two dual-vaned pivots of the prior art operating in four individual chambers.

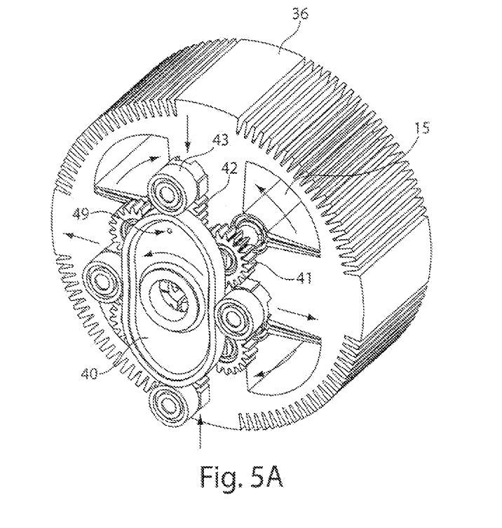

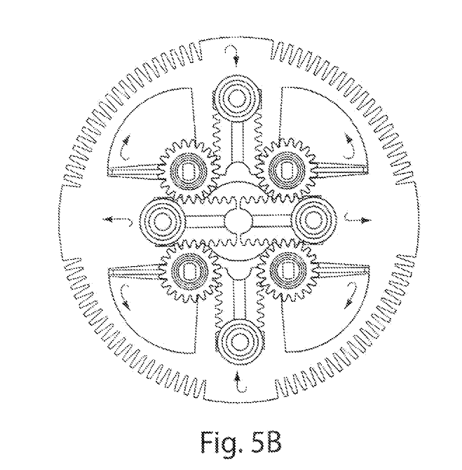

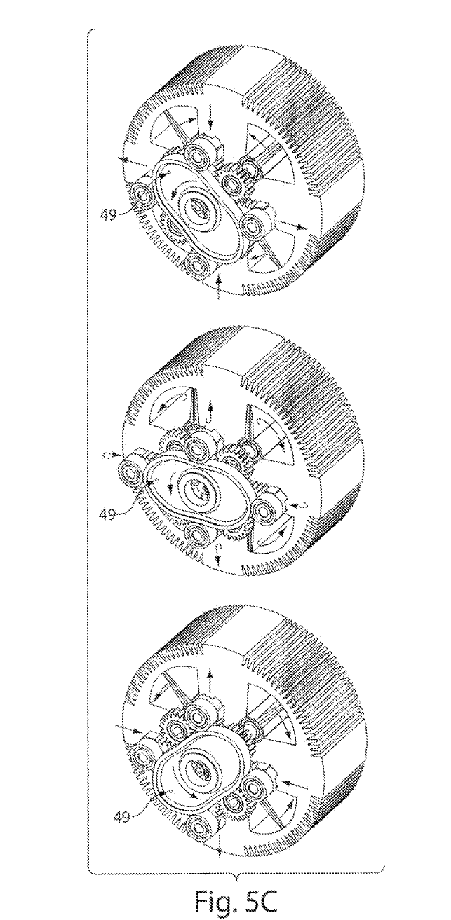

FIG. 3C shows the oscillating vane machine of the present invention having four individual pivoted vanes 10 operating in four individual main chambers 30. In accordance with the present invention, the number of individual main chambers is preferably 4; however, more or less chambers can be utilized such as 2 or 6 or 8. The main chambers 30 are contained within a stator 36. The stator may be smooth, or it may be machined to accommodate the application. In one embodiment the stator is machined to have fins or fin projections. (See FIGS. 5-21). The oscillating vane machine of the present invention may further be contained within a housing (not shown). According to the present invention, the stator and/or the housing may be coincident with or form one or more surfaces of the plurality of chambers.

The pivoted vanes 10 of the oscillating vane machine of the present invention can be chosen, selected or manufactured from a wide array of materials and can be dependent on application or the intended use of the machine. For example, at low pressure and low temperature, the pivoted vanes may be manufactured from a plastic or plastic-like material. At high pressure and temperature, it may be desired to have pivoted vanes manufactured from a stronger material such as a metal or ceramic. Therefore, according to the present invention, the pivoted vanes may be manufactured from steel, aluminum, or any metal, plastic, ceramic, composite, polymer or the like. Furthermore, it may be advantageous to plate or overmold the pivoted vanes with a layer, film or deposit of a second material. The plating or overmolding may comprise the same material as the pivoted vane substrate or may be different in kind or amount. For example, a metal pivoted vane may be plated or overmolded with a polymer or plastic to improve movement within the main chamber by reducing friction. Overmolding and plating of the pivoted vanes may be complete or only to select pivoted vane surfaces or edges or to only the pivot.

The pivoted vanes of the oscillating vane machine of the present invention may also be designed to undergo or withstand a certain degree of deformity. Generally, larger machines, (e.g., larger pivoted vanes), can withstand more deformity. It is understood in the art that one problem with oscillating vanes is detrimental harmonics. It is therefore desired to design the vanes of the present invention and the vane actuation system to avoid any detrimental harmonic events. This problem is addressed in the selection of materials, size and proportion of pivoted vanes as well as the acceleration and deceleration profiles of the oscillating motion of the pivoted vanes so that the magnitude of the pivoted vane resonance will be minimized and occur at a frequency higher than the frequency at which the pivoted vanes will be operated thereby avoiding a detrimental harmonic contribution from the pivoted vane or actuation system.

In one embodiment of the invention, the distal surface of one or more of the plurality of pivoted vanes lying parallel to the axis of the pivot is a surface which is substantially flat, convex, concave, toroidal, slanted or any nonflat shape specifiable by a mathematical equation.

In another embodiment of the invention, the lateral surfaces or side surfaces of one or more of the plurality of pivoted vanes is substantially flat, convex, concave, toroidal, slanted or any nonflat shape specifiable by a mathematical equation.

Furthermore, the pivoted vanes of the oscillating vane machine of the present invention may be rotated about their pivots at an angle of 45, 60 or 90 degrees.

In one embodiment, the pivoted vanes of the oscillating vane machine of the present invention may be double-acting while the actuation or driving mechanism of the vanes may be single-acting, double-acting, triple-acting or quadruple-acting, and the like. In one embodiment, the pivots are fixed equidistant to one another.

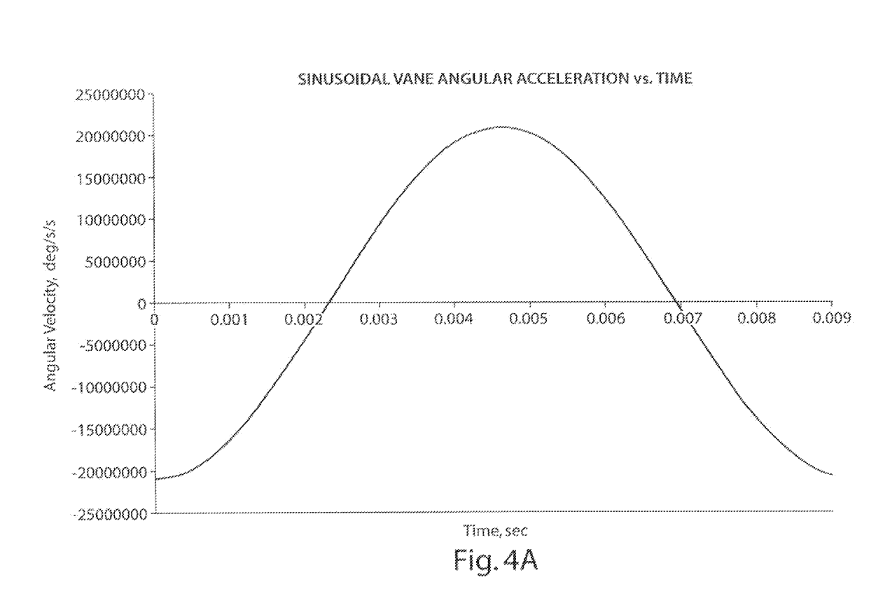

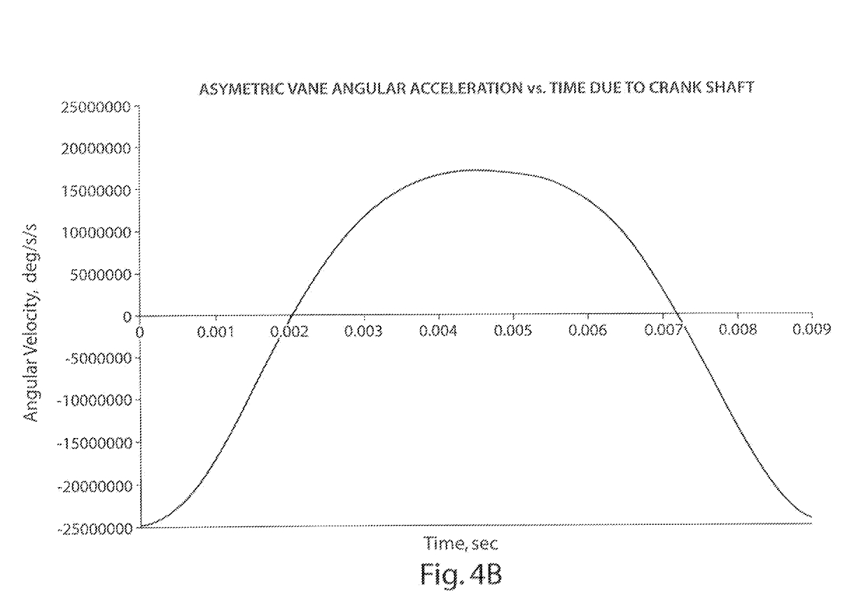

Symmetry is more important as the speed required increases. As is known in the art, the need for symmetric motion is often addressed by attempting to achieve sine curve motion. FIG. 4A shows a graph of sinusoidal acceleration and deceleration of an oscillating pivoted vane. This type of motion is well known to those skilled in the art of machine design and is preferable over other types of motion because it reduces inertial loads, which is important in high speed machines.

FIG. 4B shows a graph of the sinusoidal acceleration and deceleration of an oscillating pivoted vane when driven via a crankshaft. Notice that the graph is asymmetric meaning that the magnitude of the loads on the components are higher during one phase of the cycle than the other phase. These higher loads translate to larger inefficiencies in the mechanical system due to the addition of weight in the form of stronger components and friction due to higher loads being absorbed by the bearings which support the components. As is known to those skilled in the art, the longer the connecting rod, the more symmetric the motion becomes; however, in order to achieve the symmetry of FIG. 4A, the connecting rod would have to be infinite in length. As such, crankshaft driven systems always produce asymmetric sinusoidal motion.

Several embodiments of the present invention, unlike machines in the art, are able to produce symmetric sinusoidal motion of the oscillating vanes via novel drive mechanisms. This will allow those embodiments to operate at sufficient speeds resulting in increased flow rates from smaller machines.

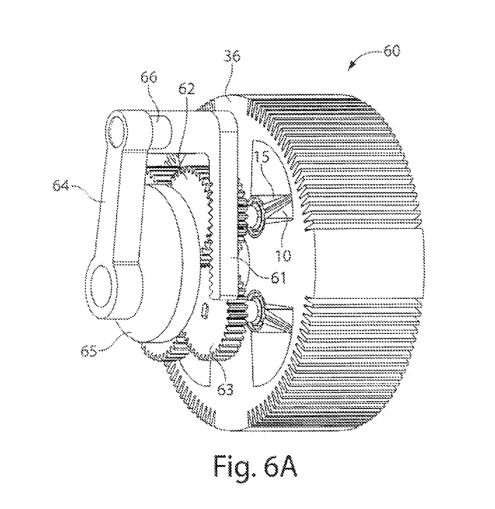

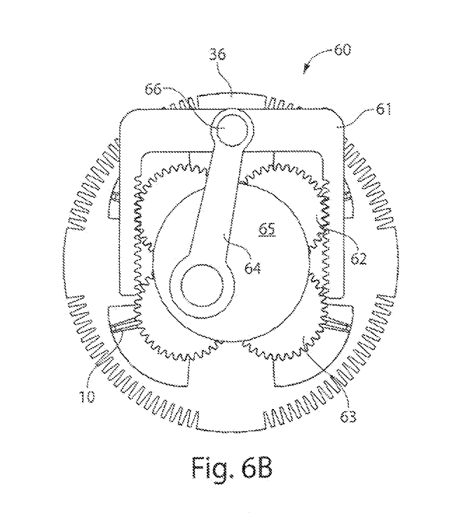

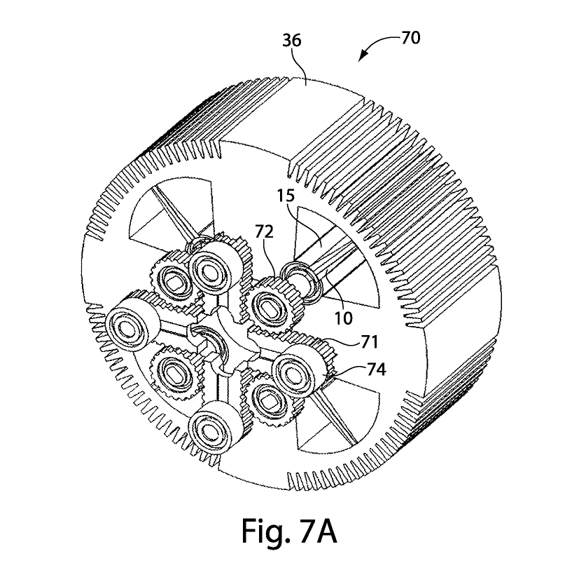

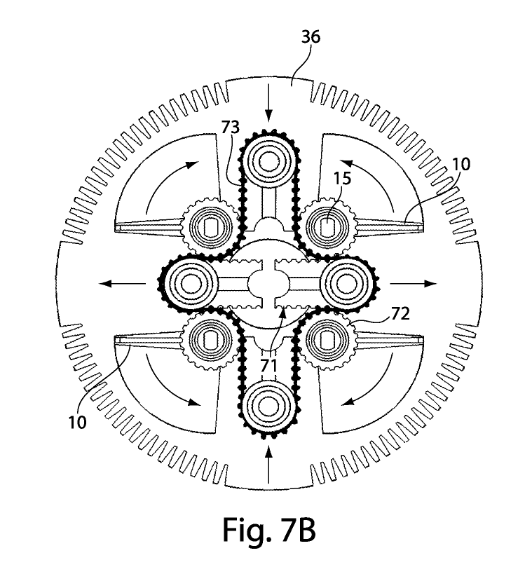

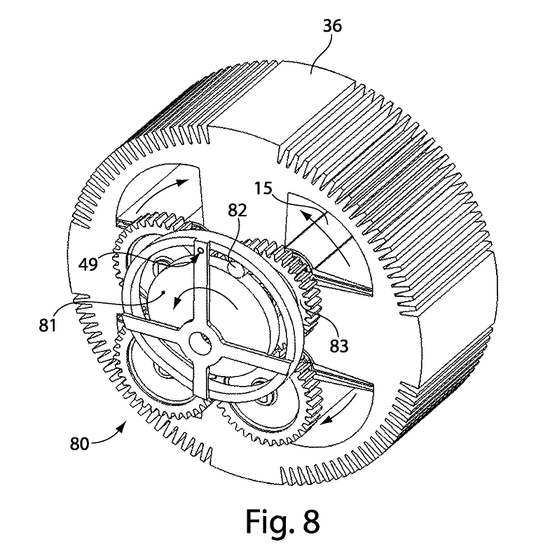

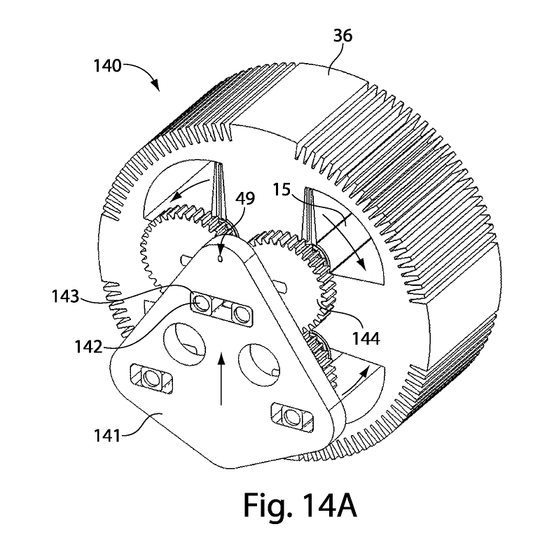

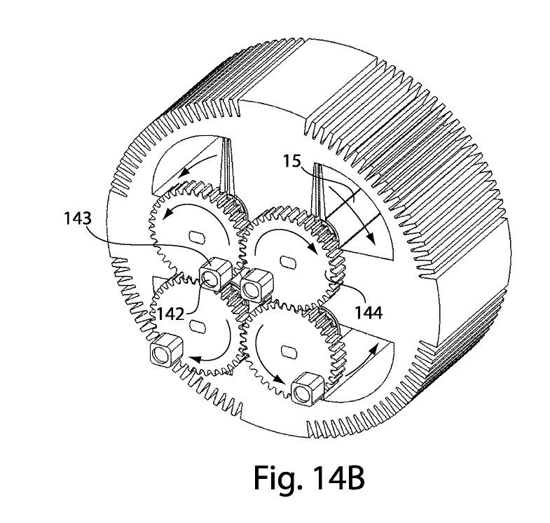

There are five categories of drive mechanisms of the present invention: Category 1 is comprised of a cam which drives a set of reciprocating racks which in turn are geared to rotary oscillating pinions which drive the vane pivots. This type of mechanism is shown in FIG. 5A-B. Category 2 is comprised of a cam, or cams, which drive pins connected to rotary oscillating pinions which drive the vane pivots without any reciprocating members. Several embodiments of this mechanism are shown in FIGS. 8 through 13. Category 3 is comprised of a conventional crankshaft and connecting rod mechanism which drive a reciprocating rack which is geared to rotary oscillating pinions which drive the vane pivots. This type of mechanism is shown in FIG. 6A-B. Category 4 is comprised of a cam which drives a set of toothed reciprocating members which convert their reciprocating motion to rotary oscillating toothed pulleys via a toothed belt. The toothed pulleys drive the vane pivots. The toothed belt does not rotate. It simply changes shape as the toothed reciprocating members move towards or away from the center of the machine. In so doing, the toothed pulleys are forced to rotate in an oscillatory manner. This type of mechanism is shown in FIGS. 7A-B. Category 5 is comprised of a conventional crankshaft and connecting rod which drive a reciprocating plate whereby pin connected to pinions are able to slide along actuation slots in the plate thereby forcing the pinions to rotate in an oscillatory fashion. The pinions are connected to the vane pivots. This type of mechanism is shown in FIG. 14A-B. The pinions can alternatively be replaced by lever arms.

It is understood by those of skill in the art that reciprocating components would require a form of linear guidance.

FIG. 5A shows an oscillating vane machine of the present invention with four pivoted vanes arranged as shown in FIG. 3C. In the figure, each of the pivoted vanes 10 is driven by a pinion 41 attached to the vane pivot 15 and actuated by a reciprocating rack 42 driven by a cam 40. It will be understood by those skilled in the art that the pinion may be replaced without undue experimentation by any driven member and that the cam driven reciprocating rack may be replaced by any suitable driving member.

Here, the cam 40 drives the reciprocating rack 42 via a roller 43 which is in rolling contact with the cam profile to reduce friction. The profile of said cam 40 is such that the driving member, here a reciprocating rack 42 imparts the desired motion to the driven member, here a pinion 41 which in turn actuates the pivoted vane 10 sinusoidally.

As the cam 40 rotates through one revolution, it imparts two complete oscillatory cycles to each of the four vanes. In the figure, the cam is labeled with a reference mark 49 to illustrate the concerted movement of and within the machine on viewing the series of figures in 5C. It is noted that if the gear arrangement disclosed by Mize (U.S. Pat. No. 2,257,884) is used, it is possible to have reciprocating racks 42 driven in opposed pairs thereby canceling out the vibrational components of each other's reciprocating masses.

FIG. 5B is a view of the embodiment of FIG. 5A having the cam removed for visual clarity. Motion arrows on the figure indicate the movement of and within the machine.

FIG. 5C is a series of views of the embodiment of FIG. 5A illustrating the concerted movement of and within the machine upon rotation of the cam. Again the reference mark has been added to the figure to aid in visualizing the motion.

FIG. 6A shows another embodiment of the oscillating vane machine of the present invention with four pivoted vanes arranged as shown in FIG. 3C.

FIG. 6A illustrates a Category 3 actuated machine 60 (Crankshaft Driven Rack). Here, reciprocating racks 61 engages two extended pinions simultaneously. In order to provide enough room for the legs of the rack to reciprocate through their full travel, the two pinions have been lengthened to create long pinions 62. The long pinions 62 are in turn geared to short pinions 63. The reciprocating racks 61 reciprocate via a connecting rod 64 and crankshaft 65. The reciprocating rack 61 is connected to the connecting rod 64 via a wrist pin 66. It will be understood by one of skill in the art that the rack may be arranged in different ways to thereby engage one, two, three or four pinions. It will also be understood by those skilled in the art that the pinions may be replaced without undue experimentation by any driven member and that the reciprocating structure comprised of two racks may be replaced by any suitable driving member.

FIG. 6B shows an elevation of the machine of FIG. 6A.

FIGS. 7A-B shows another embodiment of the oscillating vane machine 70 of the present invention with four pivoted vanes arranged as shown in FIG. 3C.

In the figure, each of the oscillating pivoted vanes 10 are driven by a reciprocating toothed pulley 71 which is actuated by a cam (not shown). This actuation is similar to the Category 1 machine. The only difference being that instead of using four pinions which are geared directly to the reciprocating racks, this machine uses a ‘synchronous’ belt. A synchronous belt is one that is toothed, typically used in applications where timing and positioning are important, which transfers the motion between the reciprocating toothed pulleys 71 and the rotating toothed pulleys 72. It is noted that the belt itself does not rotate—it simply changes shape due to the reciprocating pulleys, and as it does so, the rotating toothed pulleys rotate. FIG. 7B shows an end view of the embodiment of FIG. 7A. It shows the toothed drive belt 73 driven by a reciprocating toothed pulley 71. The cam drives the reciprocating toothed pulley via a roller 74 which is in rolling contact with the cam profile to reduce friction. The profile of the cam is such that the toothed drive belt 73 imparts the desired motion to the pulley which in turn actuates the pivoted vane 10 sinusoidally.

Taking advantage of the gear arrangement disclosed by Mize it is possible to have reciprocating members driven in opposed pairs thereby canceling out the vibrational components of each other's reciprocating masses.

It will be understood by those skilled in the art that the driven member, here a pulley and preferably a toothed pulley, may be replaced without undue experimentation by any driven member. Likewise the flexible member, here a belt, preferably a toothed belt, may be replaced without undue experimentation with another suitable flexible member.

This system has several advantages. First, the belt provides a ‘cushion’ and acts to absorb imperfections in the assembly and alignment of the system. Belt drives are also quiet and inexpensive; however, the pulley sizes must be determined according to the amount of power to be transmitted through the belt. Second, the belt ‘cradles’ roughly 25% of the rotating pulley circumference. This means that the driving load is spread out over many teeth on the belt. In comparison, a gear set usually transmits is entire power through only one or two gear teeth at any given time.

According to another embodiment of the invention, it is preferred that there be no linearly reciprocating parts involved in actuation or driving of the machine. FIGS. 8-13 illustrate variations of this category of actuation.

FIG. 8 shows an oscillating vane machine of the present invention driven by a single-acting drive mechanism. By “single-acting” it is meant that one revolution of the cam produces one complete sinusoidal oscillation of each of the four pivoted vanes.

As illustrated in FIG. 8, the single-acting Category 2 machine 80 having four pivoted vanes is driven via the motion of a cam 81 which drives a single pin 82 within a groove in the cam. The pin is operably connected to one of the pinions 83 which in turn drive the motion of the pivoted vanes via its connection to the remaining three pinions in the system, all of which are connected to the vane pivot 15 of each pivoted vane.

In FIG. 8 the cam 81 is shown as a cut-away to reveal the groove in which the pin runs. The cam in fact is a solid disc with the groove milled to allow the pin to run in the groove and to rise and fall as the cam turns.

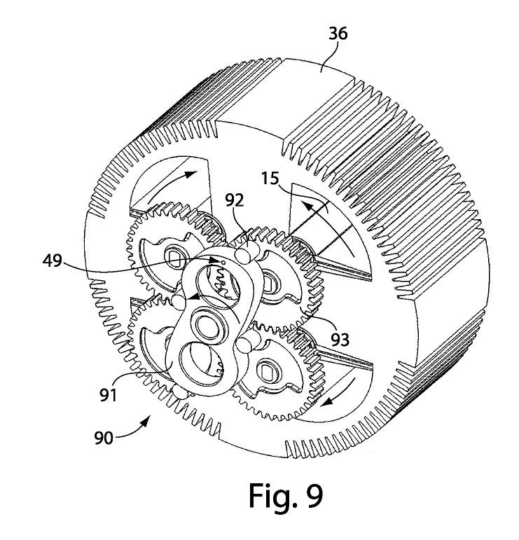

FIG. 9 shows an oscillating vane machine of the present invention driven by a double-acting drive mechanism. By “double-acting” it is meant that one revolution of the cam produces two complete sinusoidal oscillations of each of the four pivoted vanes. This embodiment is perfectly balanced and requires no additional counterweights.

As illustrated in FIG. 9, the double-acting Category 2 machine 90 having four pivoted vanes is driven via lever arms which follow the motion of a cam 91 which drives four pins 92. The pins are operably connected to the pinions 93 which in turn drive the motion of the pivoted vanes via its connection to the vane pivot 15 of each pivoted vane.

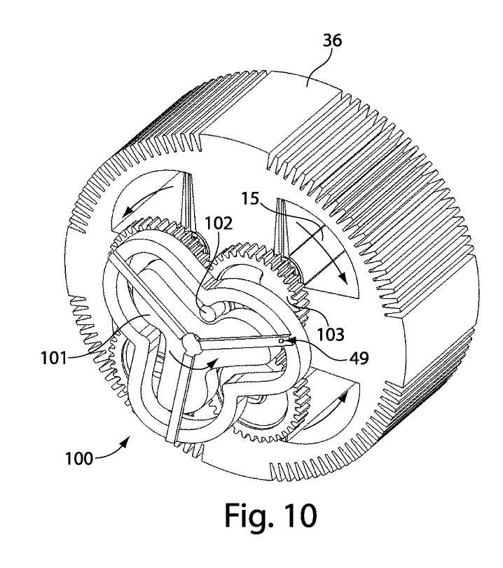

FIG. 10 shows an oscillating vane machine of the present invention driven by a triple-acting drive mechanism. By “triple-acting” it is meant that one revolution of the cam produces three complete sinusoidal oscillations of each of the four pivoted vanes.

As illustrated in FIG. 10, the triple-acting Category 2 machine 100 having four pivoted vanes is driven via the motion of a cam 101 which drives a single pin 102 within a groove in the cam. The pin is operably connected to one of the pinions 103 which in turn drive the motion of the pivoted vanes via its connection to the remaining three pinions in the system, all of which are connected to the vane pivot 15 of each pivoted vane.

In FIG. 10 the cam 101 is shown as a cut-away to reveal the groove in which the pin runs. The cam in fact is a solid disc with the groove milled to allow the pin to run in the groove and to rise and fall as the cam turns.

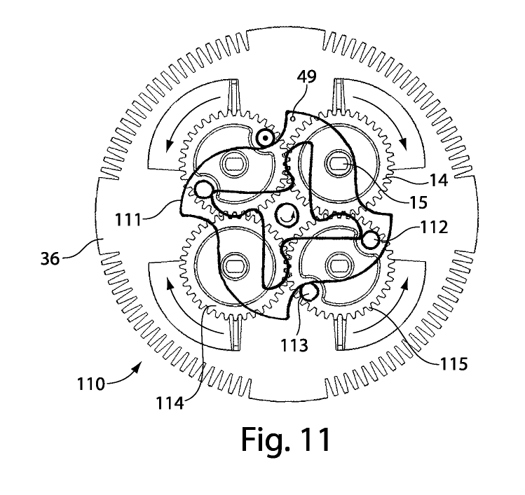

FIG. 11 shows an oscillating vane machine of the present invention driven by a quadruple-acting drive mechanism. By “quadruple-acting” it is meant that one revolution of the cam produces four complete sinusoidal oscillations of each of the four pivoted vanes. This embodiment is also perfectly balanced and requires no additional counterweights.

As illustrated in FIG. 11, the quadruple-acting Category 2 machine 110 having four pivoted vanes is driven via the motion of a dual cam 111 (drawn transparently in the figure) which drives two short pins 112 and two long pins 113. The pinions of this embodiment are characterized as pin-free pinions 114 or pin-bearing pinions 115. Pin-bearing pinions 115 in turn drive the motion of the pivoted vanes via their connection to the vane pivot 15 of each pivoted vane.

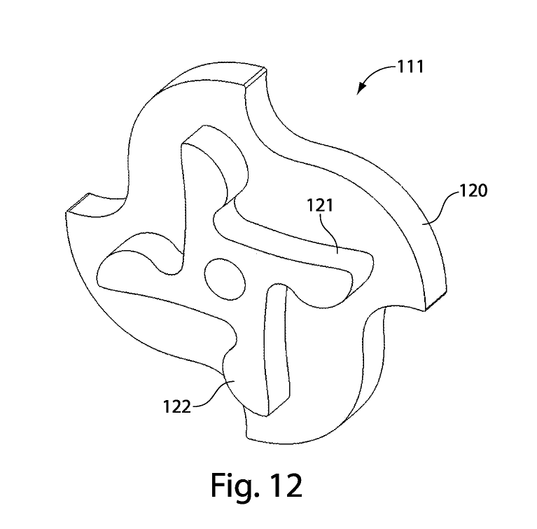

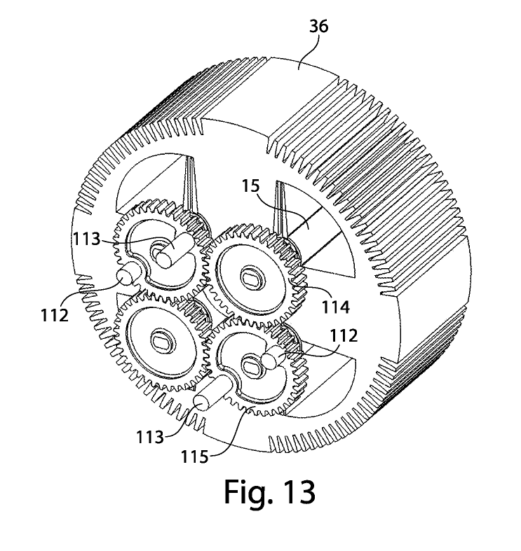

FIG. 12 shows a solid view of the dual cam 111 of FIG. 11. The cam may be manufactured or milled from a solid structure or the lobes may be manufactured separately and then attached to one another. The dual cam contains two cam contours. A first contour 120 interacts with the long pins while the second contour 121 interacts with the short pins. The bi-lobed cam 111 is seated onto the pins with the second contour 121 being the innermost facing in the machine. As such the face of the second contour represents the inner axial face 122 of the contour.

FIG. 13 is a view of the oscillating vane machine of FIG. 11, with the bi-lobed cam removed to reveal the location of the short pins 112 and long pins 113 and their interaction with the pin-free pinions 114 and the pin-bearing pinions 115.

When driving the oscillating vane machine of the present invention at an odd ratio (e.g., single-acting and triple-acting) only one pin is used and all power must be applied to this pin. However, in even driving ratios (e.g., double-acting and quadruple-acting) the power is distributed over four pins making stress on any one pin less.

FIG. 14A shows an oscillating vane machine of the present invention with four pivoted vanes arranged as shown in FIG. 3C.

As illustrated in FIG. 14A, the single-acting Category 5 machine 140 having four pivoted vanes which follow the motion of a reciprocating plate 141 with three slots which drives four pins 142. The pins are fitted with pin bushings 143 which serve to guide the round pins within the rectilinear slots in the reciprocating plate. The pins are connected to the pinions 144 which in turn drive the motion of the pivoted vanes via its connection to the vane pivot 15 of each pivoted vane. In the figure, the reciprocating plate is labeled with a reference mark 49.

FIG. 14B is a view of the embodiment of FIG. 14A having the reciprocating plate removed for visual clarity. Motion arrows on the figure indicate the movement of and within the machine. The pinions may be replaced with lever arms.

Factors which dictate the flow rate into the individual main chambers include the volume of the chamber and the speed at which the chamber is being processed. Additionally the flow through the ports dictates the maximum velocity through the ports. It is desired to keep the average gas velocity below 0.3 times the speed of sound (0.3 Mach) because at this flow, gases are treated as incompressible fluids. It is known to those skilled that minimizing gas velocity through a valve or port minimizes energy looses in the overall system; therefore, it is often endeavored to maintain average gas velolcites below 0.3 mach, preferably around 0.1 mach.

Valves useful in the present invention include stationary, rotary, hinged, poppet, reed (or high frequency valve), flapper and the like. The valves of the machine may also be arrayed linearly or in preselected patterns. In order to minimize flow restrictions, valve plates may also be used. These plates allow the chamber pressure to be the determinant factor in valve opening.

The valves of the present invention hinge away from the ports opening in response to pressure differentials and are closed mechanically. They remain closed due to an opposite pressure differential and are able to effect a tighter seal as the pressure differential increases, similar to a poppet valve. This aspect of the invention (i.e., opening the inlet and discharge ports via variable pressure and closing them mechanically) is novel in that it creates a variable pressure ratio valving system. The mechanical closure of the valves may also be timed. This actuation of the valves (i.e., opening and closing) scheme eliminates backflow on inlet as well as discharge from the chamber. In one embodiment, when the machine of the invention operates as an expander, both opening and closing of the valves is timed.

In the present invention, it is preferable that the discharge valve close at the point the pivoted vane reaches the end of its oscillation path. This keeps the pivoted vane from pulling any liquid or gas back out through the discharge port.

Actuators, or devices that operate to open and/or close a valve, may be selected based on the desired operational speed of the machine. Parameters that must be considered include the speed of actuation desired and how much actuation is necessary for a particular valve. For example, in normal engines, the amount of movement of any valve can be problematic due to the mass of the valve, resulting in “valve float.” Valve float occurs, when the speed of the engine is too great for the valve springs to control the valve, and hence the valves will stay open and/or “bounce” on their seats. Reducing the mass of the valves can reduce valve float.

Inlet porting in the oscillating vane machine of the present invention is achieved when fluid or gas (e.g., air) enters the machine via the main inlet port. The gas stream is then split into four pillars, each of which bifurcate into two ports, one to each of two adjacent main chambers.

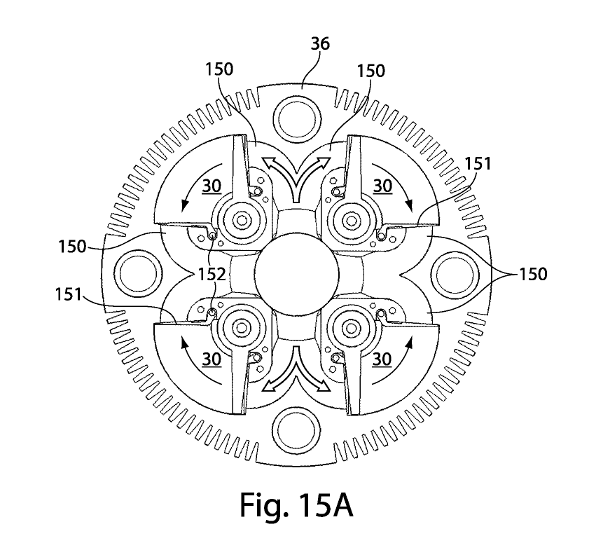

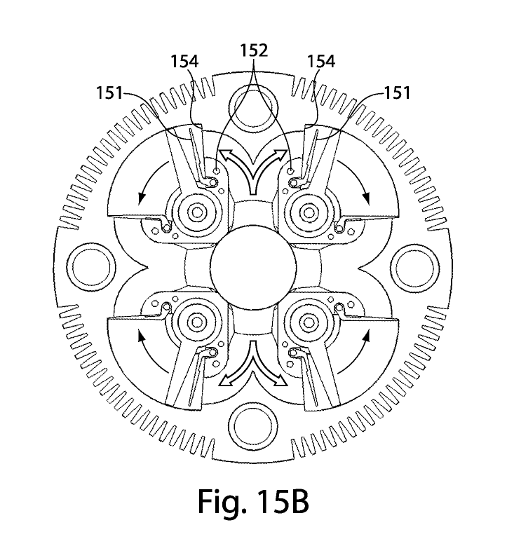

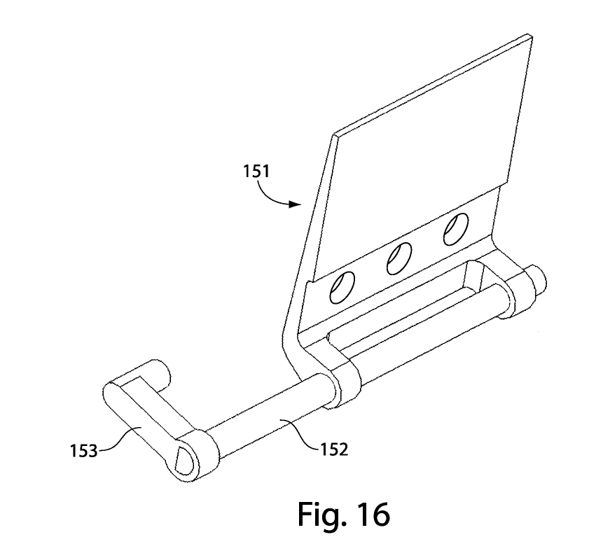

FIGS. 15A and B shows the porting face of the oscillating vane machine of the present invention with four pivoted vanes operating in four individual main chambers where each main chamber has at least one bifurcated inlet port 150 in fluid communication with each of said main chambers 30 where the flow of fluid through the inlet port is controlled by an inlet valve 151 mounted on a valve shaft 152 to which is connected an actuation arm 153 (shown in FIG. 16) where the actuation arm is activated via a cam or similar apparatus attached to the vane pivot 15. FIG. 15B shows the relative arrangement of the inlet valve 151 and the valve seat 154. The inlet valve 151 seals against a valve seat 154 which is the area around the port which the valve overlaps to effectuate the seal.

FIGS. 15A-B have been labeled with directional arrows to indicate fluid flow in the machine and to illustrate the actuation of the inlet valves.

FIG. 16 shows one unit of an inlet valve assembly of the present invention. The inlet valve 151 is mounted on a valve shaft 152 to which is connected an actuation arm 153. The actuation arm is then activated via a cam or similar apparatus.

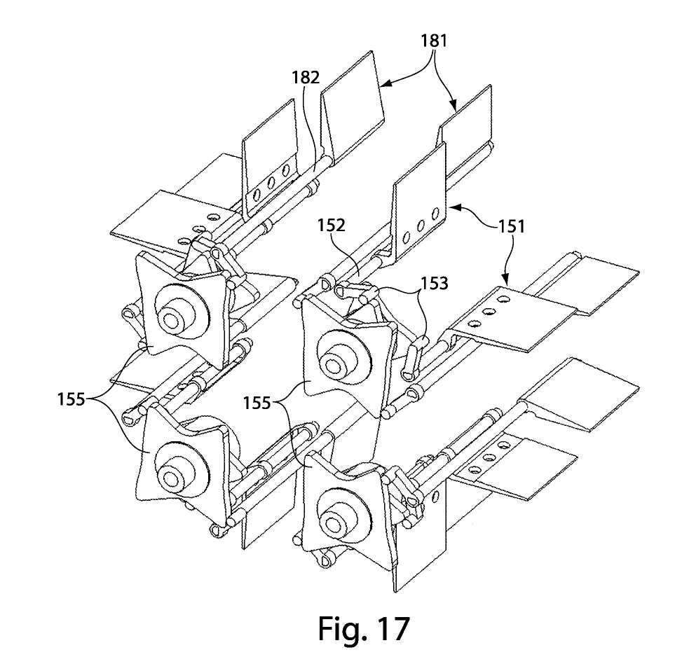

FIG. 17 shows an inlet valve and discharge valve assembly of the present invention. The inlet valves 151 are seen mounted on the valve shafts 152 to which is connected an actuation arms 153. The actuation arm is then activated via a cam 155 or similar apparatus.

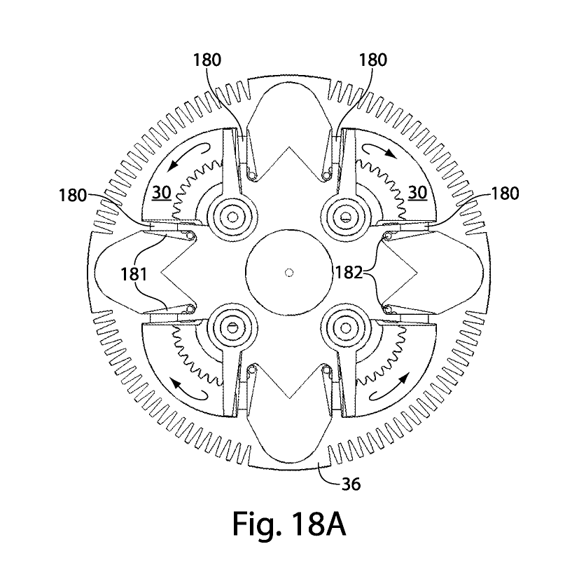

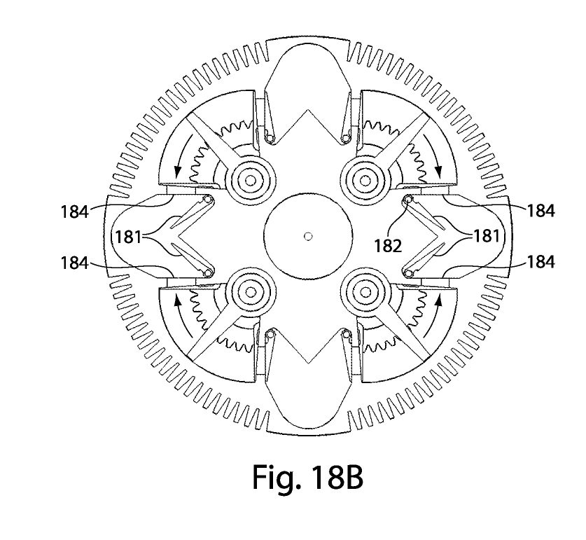

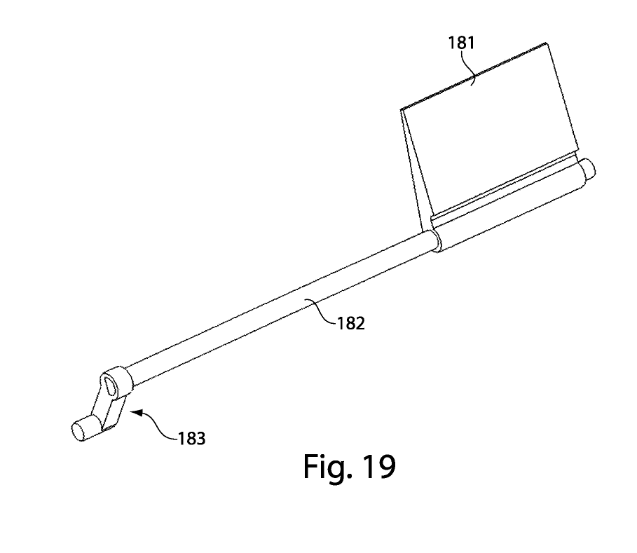

FIG. 18A shows the porting face of the oscillating vane machine of the present invention with four pivoted vanes operating in four individual main chambers where each main chamber has at least one bifurcated discharge port 180 in fluid communication with each of said main chambers 30 where the flow of fluid through the discharge port is controlled by a discharge valve 181 mounted on a discharge valve shaft 182 to which is connected a discharge actuation arm 183 (shown in FIG. 19) where the actuation arm is activated via a cam or similar apparatus attached to the vane pivot 15.

FIG. 18B shows the relative arrangement of the discharge valves 181 and the valve seat 184. The discharge valve 181 seals against a valve seat 184 which is the area around the discharge port which the valve overlaps to effectuate the seal.

FIGS. 18A-B have been labeled with directional arrows to indicate a cycle of fluid flow in the machine and to illustrate the actuation of the discharge valves. For fluid discharge, the path of flow is perpendicular to the plane of the view. One of skill in the art will understand that to indicate this flow, the path would rise out from the plane of the page at the reader from the pillars located at 3 and 9 o'clock.

FIG. 19 shows a discharge valve assembly of the present invention. The discharge valve 181 is mounted on a valve shaft 182 to which is connected an actuation arm 183. The actuation arm is then activated via a cam or similar apparatus as described herein.

The oscillating vane machine can be ported in any number of ways. Unlike any machine in the art, porting of the oscillating vane machine of the present invention is extensible with the machine. This is referred to herein as radial porting. More specifically, the ports of the oscillating vane machine of the present invention may extend axially as the machine extends axially. Consequently as the machine increases in size, the port area increases proportionally and is always in a condition of maximal fluid exchange. Hence, the present design allows extensible porting.

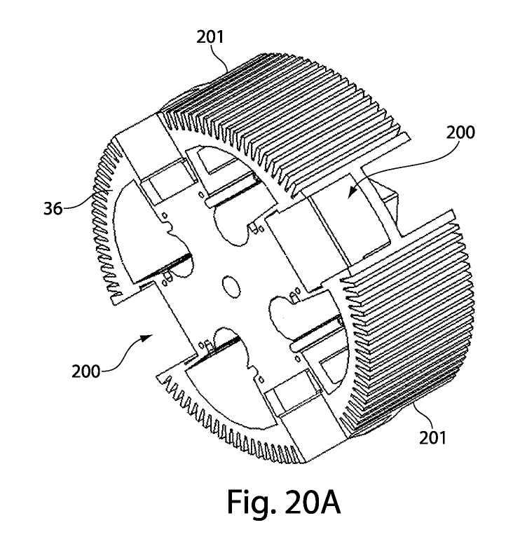

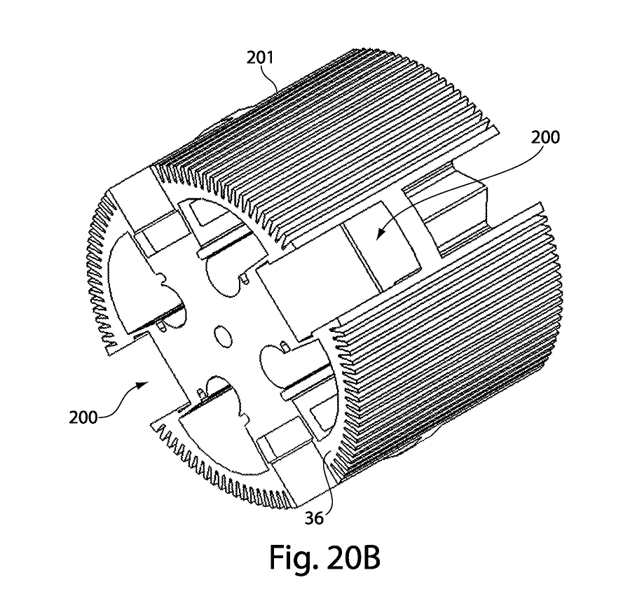

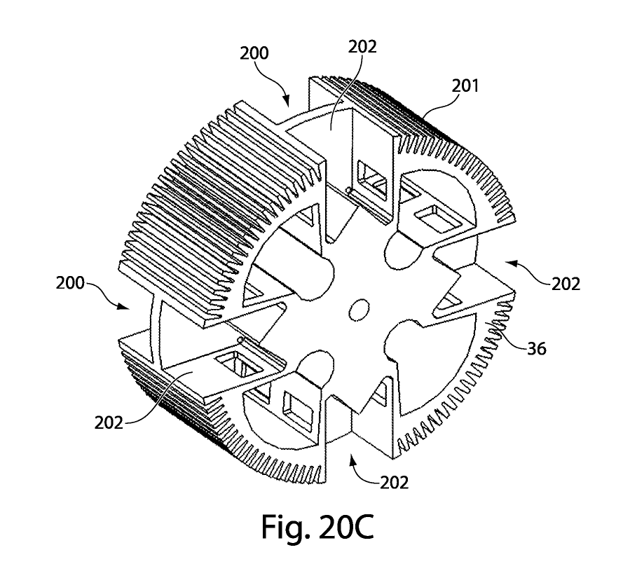

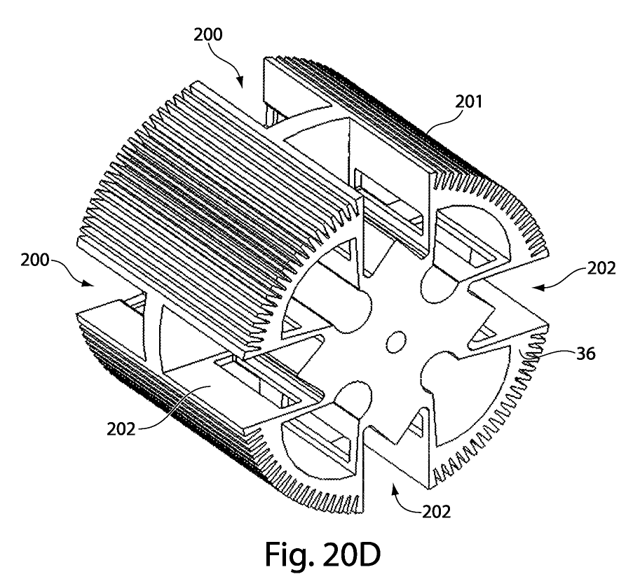

FIG. 20A shows a view of the inlet face of a machine of the present invention whereby the inlet ports are radially initiated on the outer peripheral surface of the machine. The figure illustrates four radial ports 200 whereby the fluid enters from the outer radial surface 201 of the stator 36.

FIG. 20B shows the extensible nature of this type of porting in a longer machine. FIG. 20C shows a similar view of the discharge side of the machine whereby the discharge ports are radially terminated on the outer peripheral surface of the machine.

The advantage of such an arrangement is that when the machine is extended in length, with an according increase in chamber volume, the ports of FIG. 20A and C are also extended to provide sufficient area for the effective flow of fluid into the enlarged chamber volumes. This is shown in FIGS. 20B and 20D, inlet side and discharge side respectively.

FIG. 20C illustrates four radial discharge ports 202 whereby the fluid exits from the chambers of the machine to the radial ports in the stator. FIG. 20D shows the extensible nature of this type of discharge porting in a longer machine.

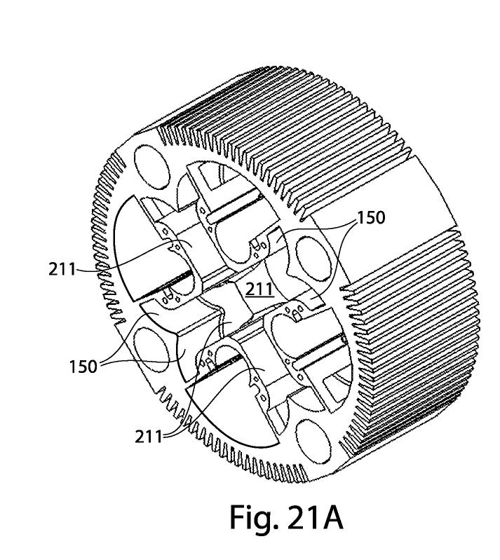

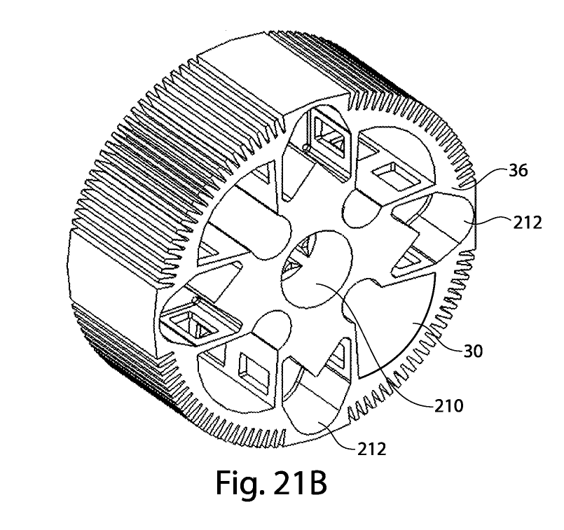

In applications where there is severely restricted radial space available, the machine can also be ported on its axial faces. FIG. 21A shows the inlet face of another embodiment of the machine of the present invention whereby the inlet ports are initiated on the inlet face. FIG. 21B shows the discharge face of the machine of FIG. 21A with the discharge ports being terminated on the discharge face. The ports in this embodiment are axially located as opposed to radially located as in the previous embodiment.

Axial porting as depicted in FIG. 21A-B shows the central axial inlet port 210 (shown in FIG. 21B from the discharge side of the stator) which splits into four pillars 211 which then each bifurcate to form two inlet ports 150. FIG. 21B illustrates axial discharge porting of the oscillating vane machine of the invention. The discharge ports 212 receive fluid from the main chamber and then discharge the fluid axially.

FIG. 21B illustrates axial discharge porting of the oscillating vane machine of the invention.

According to the present invention, the cams may be configured to comprise a “dwell” (e.g., pause) at any stage during the cycle causing a pause of the action of the pivoted vanes.

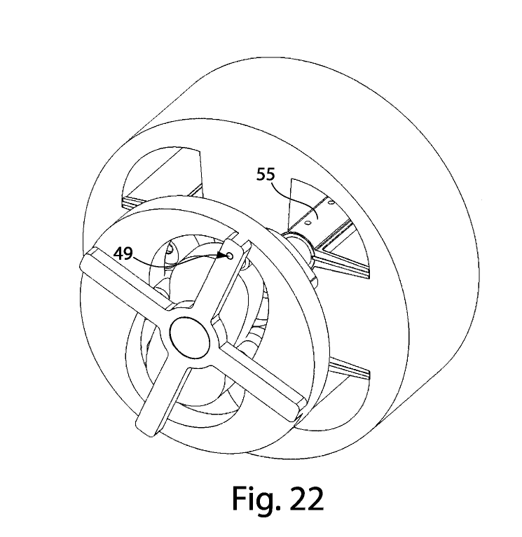

FIG. 22 illustrates an example of a cam configured with a dwell characterized by a recessed portion in the lobe or contour. This figure depicts the oscillating vane machine of the invention as in FIG. 9. The vanes oscillate through one complete cycle while the cam rotates through one-half of its cycle, thus, the cam is double acting as in FIG. 9.

In the figure, the grooved bi-lobed cam actuates four pins. This configuration is especially effective at high speeds in order to transmit sufficient power to the pivoted vanes. In this embodiment the geared pinions have been replaced with lever arms.

Furthermore, in the absence of any gas pressure for stabilization, at high speeds, inertia presents a problem. However, when pressurized, the gas pressure in the machine decreases the load on the machine.

Cams of the present invention may have one or more dwells and the dwells may be symmetric or asymmetric. Incorporation of dwells allows the machine of the invention to perform operations at constant volume. This is especially advantageous with expanders.

It is also known that heat addition to a system is most efficient when the heat is added at constant volume. Utilization of a cam dwell in the present invention allows for exploitation of power cycles which operate at least in part at constant volume such as those described in U.S. Patent Application 60/860,163, (Attorney Docket Number 4004.3022 US) filed Nov. 20, 2006, entitled Systems and methods for producing power using positive displacement devices the contents of which are incorporated herein by reference in their entirety.

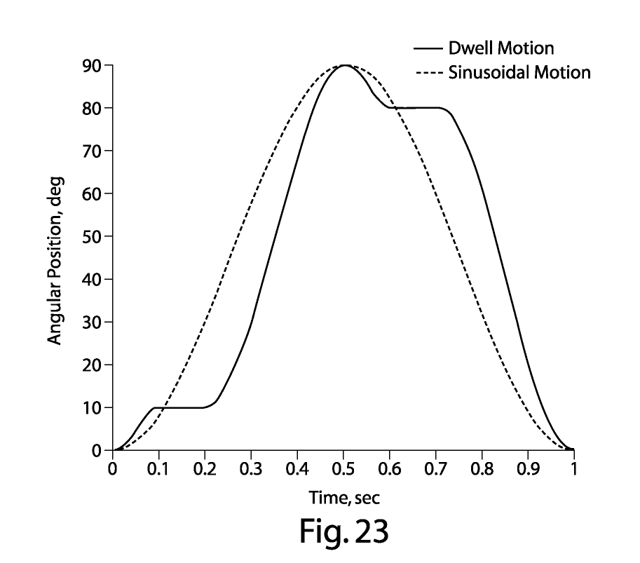

FIG. 23 (a graph of Angular Position vs. Time for a single oscillation of a vane) illustrates the acceleration and deceleration profiles of an oscillating pivoted vane configured in the oscillating vane machine of the present invention having a dwell-containing cam. The figure illustrates multiple dwells and plateaus and shows the difference in the vane motion between pure sinusoidal motion and motion with dwell. The vane position starts at 0 degrees, travels to 90 degrees, and then returns back to 0 degrees. The dotted line shows the vane position using sinusoidal motion. The solid line shows the vane position when a dwell is inserted. The vane starts at 0 degrees and travels to 10 degrees where it dwells at that position for 10% of the cycle, then it travels to 90 degrees, changes direction, returns to 80 degrees where it dwells for another 10% of the cycle, after which it moves back to 0 degrees. The absolute measure of time is not critical because if the machine is operating at a slower or faster speed then the amount of time per event will be larger or smaller. Hence the motion is normalized to 1 second to show a possible proportion of time at dwell versus time for the overall event. In the figure, the dwell was chosen to occur arbitrarily at 10 and 80 degrees. In practice, the dwell location and duration are determined by the application and may occur at any values between 0 and 90 degrees.

In one embodiment, the driving mechanism may comprise a grooved multi-lobed cam lacking gears which actuates multiple pins independently and simultaneously and whereby one revolution of the cam produces one or more complete sinusoidal oscillations of each of the four pivoted vanes. The oscillating vane machine ports can be located in any number of positions.

The valves of the oscillating vane machine of the present invention may be in fluid communication with the atmosphere, each other or other devices.

According to the present invention, all rubbing or contacting surfaces between the pivoted vanes and the housing, stator or main chambers, are designed to ensure minimal frictional losses. As such, materials used for manufacturing the machine and for surface coatings or treatments should be carefully matched. Optimization of sealing conditions and selection of sealing materials or lubricants is within the skill of the art. Furthermore, when the relevant housing or stator components and the vane are made from low expansion, low friction materials, such as ceramics, it may be practicable to dispense with lubrication altogether.

According to the present invention, seals are formed between the pivoted vanes and the lateral and distal surfaces of the chambers. In addition, the pivots of each vane form a conformal seal with the stator or housing.

In one embodiment the pivoted vanes are configured with balanced seals. Balanced seals allow for higher operational speeds without the manifestation of a deforming centrifugal force resulting on the distal vane surface 13 or the lateral vane surface 14 as is seen with sliding vane machines of the art.

The seals used may comprise any sealing material including composites, plastics, rubber, Teflon, and the like.

The oscillating vane machine of the present invention is useful as a compressor. As such, the compression achieved by the machine may be substantial in any leading chamber, and even more when multi-staged.

In another embodiment, the oscillating vane machine of the present invention operates as an expander. As such, inlet ports act to allow sufficient compressed fluid to enter the chamber then allow the compressed fluid to drive the vanes, extracting work until final exhaust at a pressure equivalent to that desired at the discharge port.

When the application of the invention requires the compressor to remain in constant operation, capacity control devices become necessary. Therefore, in one embodiment, the oscillating vane machine of the present invention comprises a capacity control device. These devices act to re-route or bypass the normal compression process and thereby minimize the electricity used by the compressor when demands for compressed gas are low. Capacity control devices include, but are not limited to, a valve, a bypass circuit, a throttle plate and any combination thereof.

Employing flow bypass in the oscillating vane machine of the present invention it is possible to achieve at least five levels of output (0%, 25%, 50%, 75% and 100%) running at a constant speed. This is possible due to the design of the four pillars and their bifurcation into dual ports which feed into the four main chambers.

For example, at 0% flow it must be true that either a) no fluid or gas enters, b) any fluid or gas that does enter isn't pressurized and is sent back out to the atmosphere, or c) all of the fluid or gas entering and that isn't pressurized is recirculated within the system.

To selectively control the capacity of the machine of the invention, a bypass strategy is selected whereby one or more pillars is shut off (i.e., discharged fluid or gas is ported back into the inlet valve and recirculated within that pillar). To achieve the recirculation, is simply a matter of placing a valve between the discharge port and the inlet port.

Depending on the number of pillars shut off, capacity and therefore output can be controlled yet still allow the machine to run at a constant speed. Shutting off one pillar results in a 25% reduction in capacity, while two pillars results in a 50% reduction, three in a 75% reduction and four totally eliminating output with all flow being recirculated.

When used as a compressor, the oscillating vane machine of the present invention may also be equipped with an unloader. Unloaders are necessary to reduce the wear on the machine during high amperage drawing events such as on initial startup. When at speed the unloader may then become the loader. When unloading it is not desirable to have any pressure buildup in the machine. To counter this, bypass of all four pillars as referred to above, is triggered. When the machine is up to speed however the amperage will go down and then it becomes possible to introduce more load in the form of gas compression. To implement this loading, the bypasses triggered earlier need only be switched off or reversed.

Multi-staging of the machine of the invention can be accomplished in much the same way as the bypass described above. Multi-staging may occur in 2, 3 or 4 stages and may further comprise an intercooler. During multi-staging in a four chamber machine, not all of the chambers need be at the same pressure. For example three main chambers may be ported and valved to compress the fluid or gas which is then ported to the fourth chamber. Optionally an intercooler may be inserted between the first three chambers (stage 1) and the fourth chamber (stage 2).

In this way, multistaging increases the efficiency of the machine as it reduces the electricity necessary to compress the fluid or gas as long as an intercooler or other means of rejecting heat between stages is utilized.

The present invention is also amenable to applications of variable pressure ratio multi-staging. In this application, the chambers can be dynamically reassigned to improve performance particularly at high pressure ratios like those used in storage compressor facilities.

It may also be necessary to incorporate a cooling system into the oscillating vane machine of the present invention. Coolants useful in such as system include water, oil, a refrigerant or the like. Additionally, the coolant may act as a lubricant.

There are many properties of the present invention that may be optimized or altered to improve the performance of the machine at high speed. For example, in the automotives industry, reduced weight, increased power density at low cost is critical. The present invention solves all three of these problems.
(1) Weight—As a substantial portion of the oscillating vane machine of the present invention comprises the open space of the chambers, the overall weight of the machine is less.
(2) Power density—In order to produce a high power density machine, it is necessary to eliminate bending moment and optimize porting and maximize fluid flow. As described herein, the present invention solves all three problems.
(3) Cost—As less material and articulating members are necessary in the machine of the invention, coupled with the simplicity of the design, cost of manufacture of the oscillating vane machine of the invention will be less than conventional compressors and expanders.

The present invention has applications in power supply configurations (either functioning as a compressor or expander) which exploit natural resources such as solar, geothermal, wind power.

While this invention has been particularly shown and described with references to preferred embodiments thereof, it will be understood by those skilled in the art that various changes in form and details may be made therein without departing from the scope of the invention encompassed by the appended claims.

What is claimed is:

1. An oscillating vane machine comprising:
(a) a plurality of pivoted vanes each comprising
(i) a vane, said vane being defined by a first side vane surface, a second side vane surface, a distal vane surface, a first lateral vane surface and a second lateral vane surface, wherein said distal vane surface defines a distal vane surface path and said first and second lateral vane surfaces define first and second lateral vane surface paths when the vane is rotated about a pivot axis, and
(ii) a pivot comprising said pivot axis,
(b) a plurality of individual main chambers each defined by
(i) a distal chamber surface which is defined by said distal vane surface path,
(ii) a first end wall chamber surface
(iii) a second end wall chamber surface
(iv) a first lateral chamber surface defined by said first lateral vane surface path and extending from the radius of the vane pivot to the distal chamber surface, and
(v) a second lateral chamber surface defined by said second lateral vane surface path and extending from the radius of the vane pivot to the distal chamber surface,
(c) a driver which drives all pivoted vanes in a balanced and oscillating motion;
(d) at least one inlet port in fluid communication with each individual main chamber; and
(e) at least one discharge port in fluid communication with each individual main chamber.

2. The oscillating vane machine of claim 1 further comprising a housing or stator.

3. The oscillating vane machine of claim 2 wherein said pivot forms a conformal seal with said housing or stator.

4. The oscillating vane machine of claim 2 wherein the housing or stator is coincident with one or more surfaces of said plurality of individual main chambers.

5. The oscillating vane machine of claim 1 wherein the distal vane surface of each pivoted vane forms a seal with the distal chamber surface of each individual main chamber in which it is located.

6. The oscillating vane machine of claim 1 having four individual main chambers wherein one pivoted vane is disposed within each individual main chamber.

7. The oscillating vane machine of claim 1 further comprising an unloader.

8. The oscillating vane machine of claim 1 further comprising a capacity control device.

9. The oscillating vane machine of claim 1 used in a multistaged configuration.

10. The oscillating vane machine of claim 9 wherein the multi-staging occurs in 4 stages.

11. The oscillating vane machine of claim 9 further comprising an intercooler.

12. The oscillating vane machine of claim 1 wherein the plurality of pivoted vanes rotating about their pivots within said plurality of individual main chambers are double-acting.

13. The oscillating vane machine of claim 1 which is self balanced and wherein the driver is a cam drive with an even number of lobes.

14. The oscillating vane machine of claim 1 wherein the inlet and discharge ports are located in the end wall surfaces of the individual main chambers.

15. The oscillating vane machine of claim 14 wherein the inlet are valves and wherein said valves are in fluid communication with the suction volumes.

16. The oscillating vane machine of claim 15 wherein actuation to open the valves is achieved as a result of differential pressure across said valves.

17. The oscillating vane machine of claim 16 wherein the actuation to close the valves is achieved mechanically.

18. The oscillating vane machine of claim 1 wherein the driver comprises a cam.

19. The oscillating vane machine of claim 18 wherein the cam comprises at least one dwell.

20. The oscillating vane machine of claim 6 which is an oscillating vane compressor.

21. The oscillating vane machine of claim 6 which is an oscillating vane expander.

22. The oscillating vane machine of claim 1 wherein the oscillating motion of said plurality of pivoted vanes is sinusoidal.

23. The oscillating vane machine of claim 1 wherein the driver is selected from the group consisting of a rack and pinion system, a cam and camshaft, a rod and crankshaft, a desmodromic drive system, a cam with one or more springs, a cam and rod, reciprocating gears attached to the pivots, a dual cam with pins, a dual cam with gears, a tangential torquing device, and any combination thereof.

24. The oscillating vane machine of claim 14 wherein the discharge ports are valves.

25. The oscillating vane machine of claim 24 wherein the vales are in fluid communication with the discharge volumes.
